(19) United States
(12) Patent Application Publication
(10) Pub. No.: US 2011/0205937 A1
(43) Pub. Date: Aug. 25, 2011

(54) PULL BASED INTER-OPERATOR INTER-DEVICE TRANSFER

(75) Inventors: Milan Patel, Middlesex (GB); Kamel M. Shaheen, King of Prussia, PA (US)

(73) Assignee: INTERDIGITAL PATENT HOLDINGS, INC., Wilmington, DE (US)

(21) Appl. No.: 13/004,712

(22) Filed: Jan. 11, 2011

Related U.S. Application Data
(60) Provisional application No. 61/294,184, filed on Jan. 12, 2010.

(51) Int. Cl. H04W 4/00

(52) U.S. Cl. 370/259

(57) ABSTRACT

Methods and apparatus for pull based inter-operator inter-device transfer are described. Methods include anchoring the inter-device transfer signaling solely at a source operator, solely at a target operator and jointly at the source and target operators.

### CROSS REFERENCE TO RELATED APPLICATIONS

This application claims the benefit of U.S. provisional application No. 61/294,184 filed Jan. 12, 2010, the contents of which is hereby incorporated by reference herein.

### FIELD OF THE INVENTION

This application is related to wireless communications.

### BACKGROUND

The Internet Protocol (IP) Multimedia Subsystem (IMS) is an architectural framework for delivering IP-based multimedia services. A wireless transmit/receive unit (WTRU) may connect to an IMS through various access networks, including but not limited to networks based on technology such as Universal Mobile Telecommunications System (UMTS) Terrestrial Radio Access Network (UTRAN), Long Term Evolution (LTE), Worldwide Interoperability for Microwave Access (WiMax), or Wireless Local Area Network (WLAN) technology. A WTRU may access the IMS through a packet-switched (PS) domain. Through the use of IMS Centralized Services (ICS), a WTRU may additionally access IMS services via a circuit-switched (CS) domain.

Inter-device transfer (IDT) allows a communication session to be transferred from one device (e.g., a WTRU, a local area network (LAN) or wireless LAN computer, a voice over IP communications device or any other device connected to any communications network via IP) to another.

### SUMMARY

Methods and apparatus for pull based inter-operator inter-device transfer are described. Methods include anchoring the inter-device transfer signaling solely at a source operator, solely at a target operator and jointly at the source and target operators.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 2 shows an inter-device transfer (IDT) within one operator;

FIG. 3 shows a flow diagram for a IDT within one operator;

FIG. 4 shows another flow diagram for a IDT within one operator;

FIG. 5 shows an example inter-operator IDT;

FIG. 6 shows an example diagram of a pull based inter-operator IDT that is anchored at a source operator;

FIG. 7 shows an example flow diagram of a pull based inter-operator IDT that is anchored at a source operator;

FIG. 8 shows an example flow diagram of a pull based inter-operator IDT that is anchored at a target operator; and

FIG. 9 shows an example flow diagram of a pull based inter-operator IDT that is anchored at both source and target operators.

### DETAILED DESCRIPTION

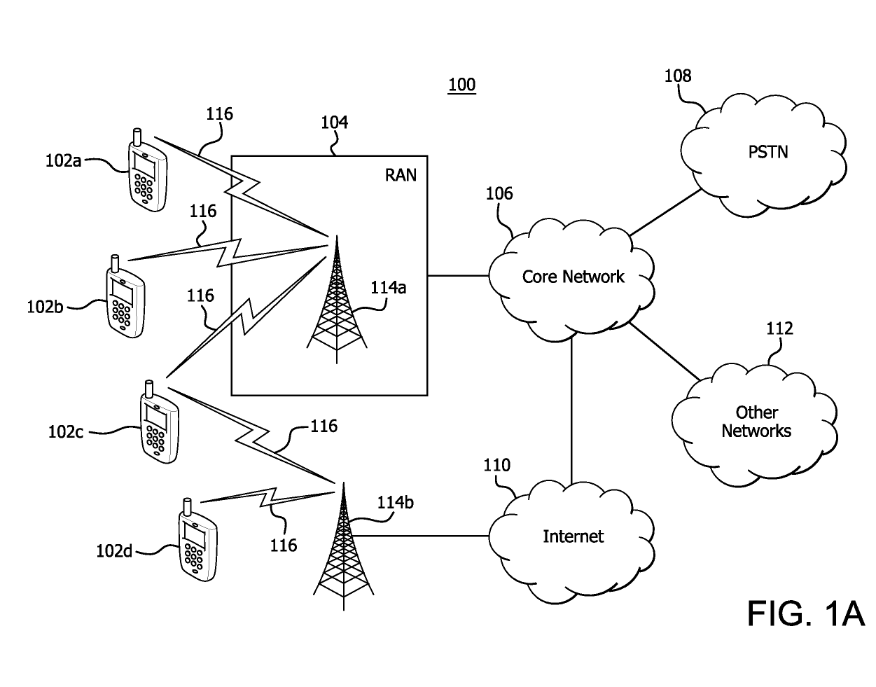

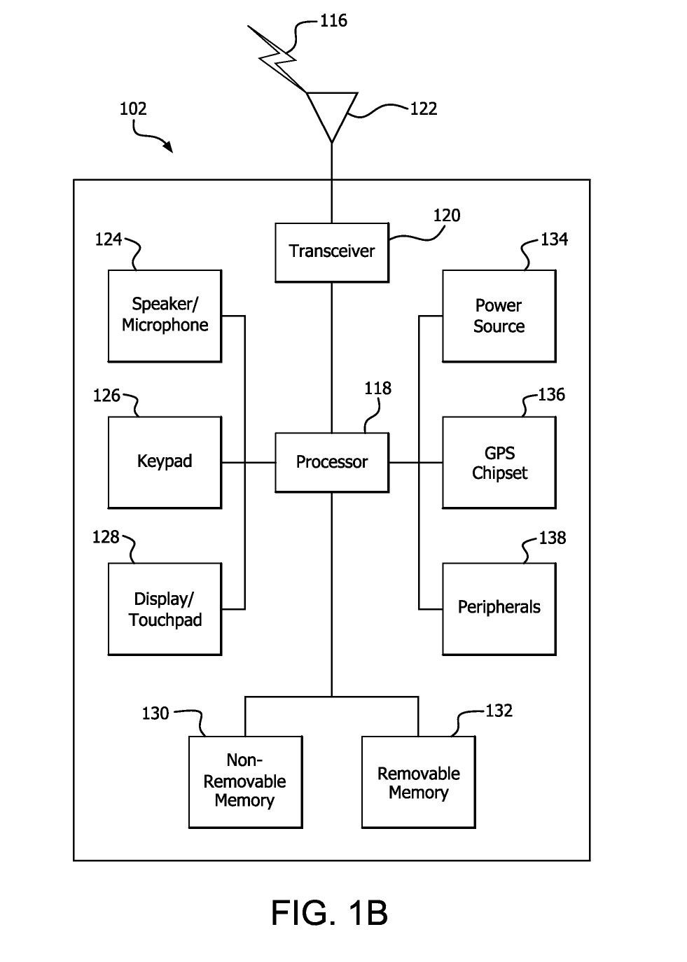

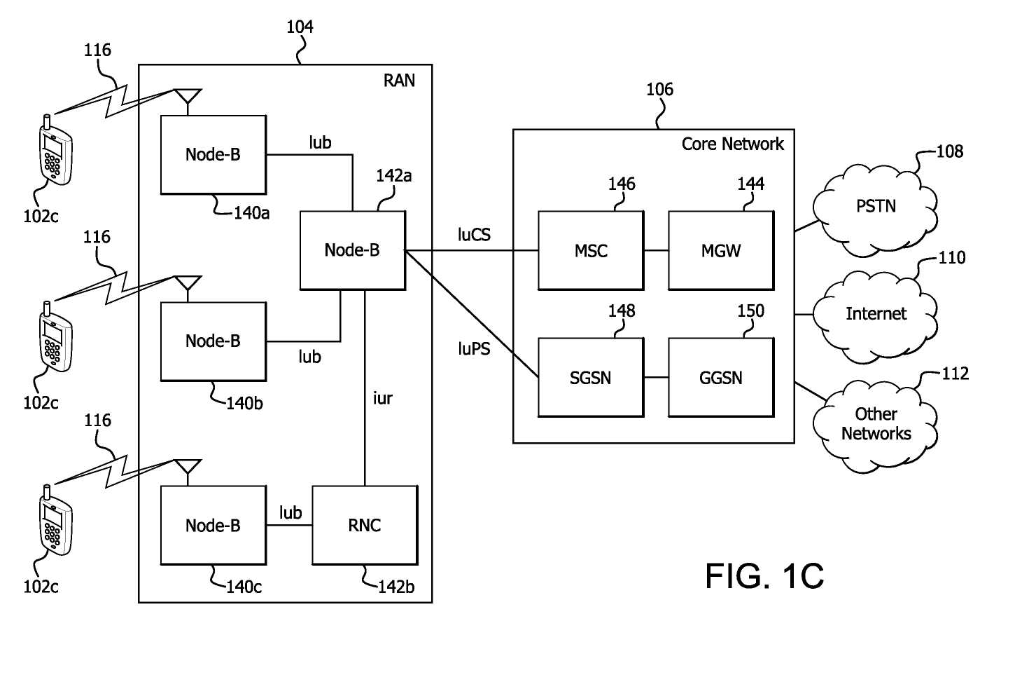

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a touchpad, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over air interface(s) 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

In other embodiments, the base station 114a and the WTRUs 102a, 102b, 102c may implement any combination of the aforementioned radio technologies. For example, the base station 114a and the WTRUs 102a, 102b, 102c may each implement dual radio technologies such as UTRA and E-UTRA, which may concurrently establish one air interface using WCDMA and one air interface using LTE-A respectively.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with one or more cells (not shown), each possibly on different carrier frequencies, and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 142a, 142b, 142c in the RAN 104 via an S1 interface and may serve as a control node. For example, the MME 142 may be responsible for authenticating users of the WTRUs 102a, 102b, 102c, bearer setup/configuration/release, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

The LTE network shown in FIGS. 1A, 1B and 1C is just one example of a particular communication network and other types of communication networks may be used without exceeding the scope of the present disclosure. For example, the wireless network may be a Universal Mobile Telecommunication System (UMTS) network, a Global System for Mobile communication (GSM) network or a Worldwide Interoperability for Microwave Access (WiMax) network.

When referred to hereafter, the terminology “inter-device transfer (IDT)” includes, but is not limited to, a inter-device media transfer, a communication session transfer, a handoff, a handover, a collaborative session transfer, session mobility, some or all media flows, service control, or any other transfer or duplication of a media flow or control signaling for use in wireless communication.

When referred to hereafter, a device may refer to a device that is capable of communicating using one or more Internet Protocol (IP) Multimedia Subsystem (IMS)-based or IMS-related protocols, such as a device that includes an IMS client. A device may refer to a WTRU, a local area network (LAN) or wireless LAN computer, a voice over internet protocol (IP) communications device or any other device connected to any communications network via IP. A device may be configured to access an IMS via the IMS client and a packet switch (PS) domain or access the IMS via the circuit switch (CS) domain.

Although the examples described herein are with respect to a WTRU, an inter-device transfer (IDT) may allow a communication session as described above to be transferred from one device to another device. The use of WTRU in the examples described herein is for illustrative purposes only.

An IP Multimedia Subsystem (IMS) user may transfer a communication session from one device to another for a number of reasons. For example, the user may want to share the media with another user, take a session or session components and move away from the device that is currently involved in the session, or want to transfer media to devices more capable of handling the media, (i.e. a larger screen, clearer audio, and the like). In addition, the device currently involved in the session may have low battery or poor radio coverage, the remote end device may change media characteristics or add further media and current source device may not function well in the new configuration.

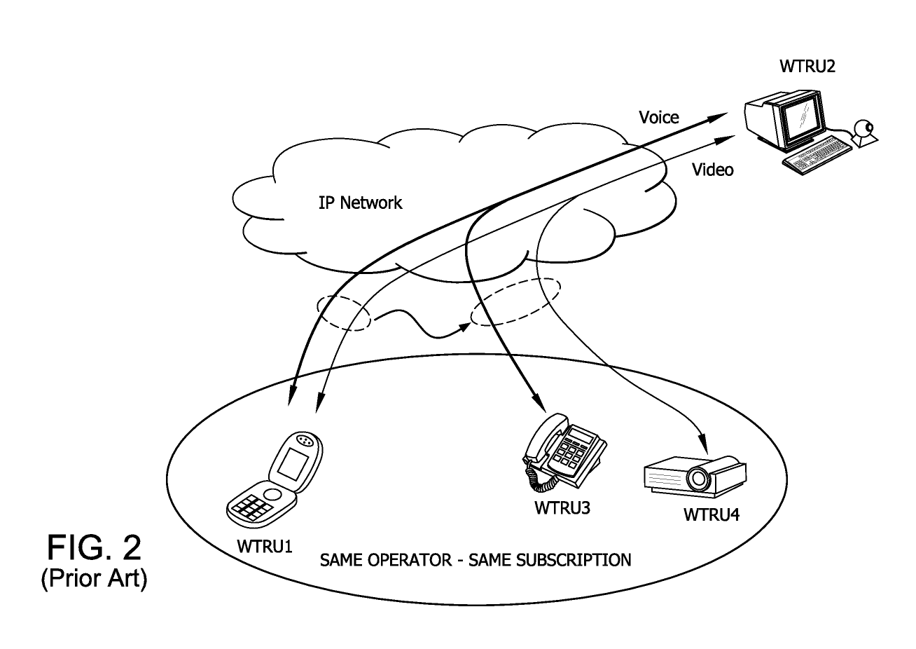

FIGS. 2, 3 and 4 show different perspectives of an IDT within one operator. FIG. 2 shows an overview of a single operator IDT. In particular, FIG. 2 illustrates that an IMS user may have a multimedia session over a device WTRU-1 with voice and video media components. Subsequently, the user may initiate an IDT of the voice component from device WTRU-1 to device WTRU-3 and the transfer of the video component from device WTRU-1 to device WTRU-4. In the examples described herein, an operator may refer to a network, system or the like.

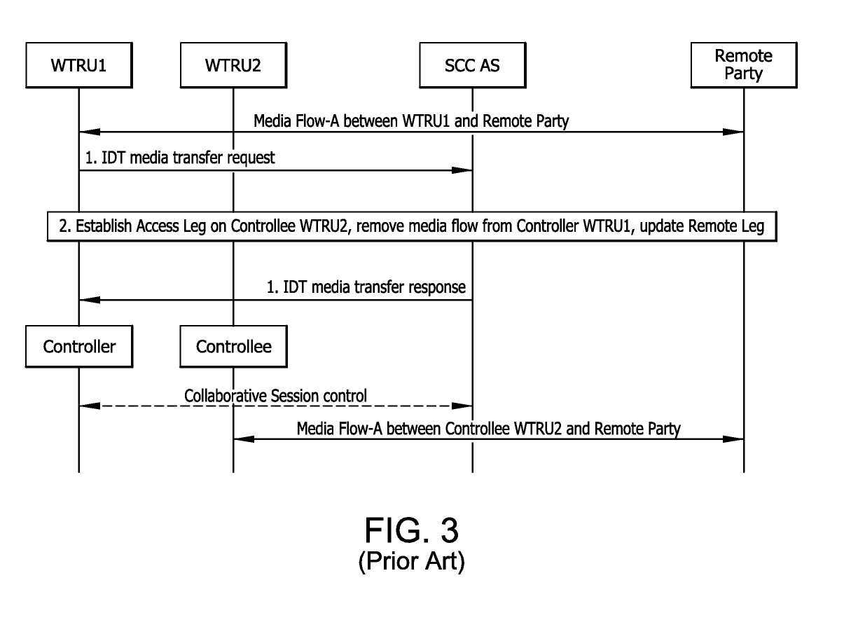

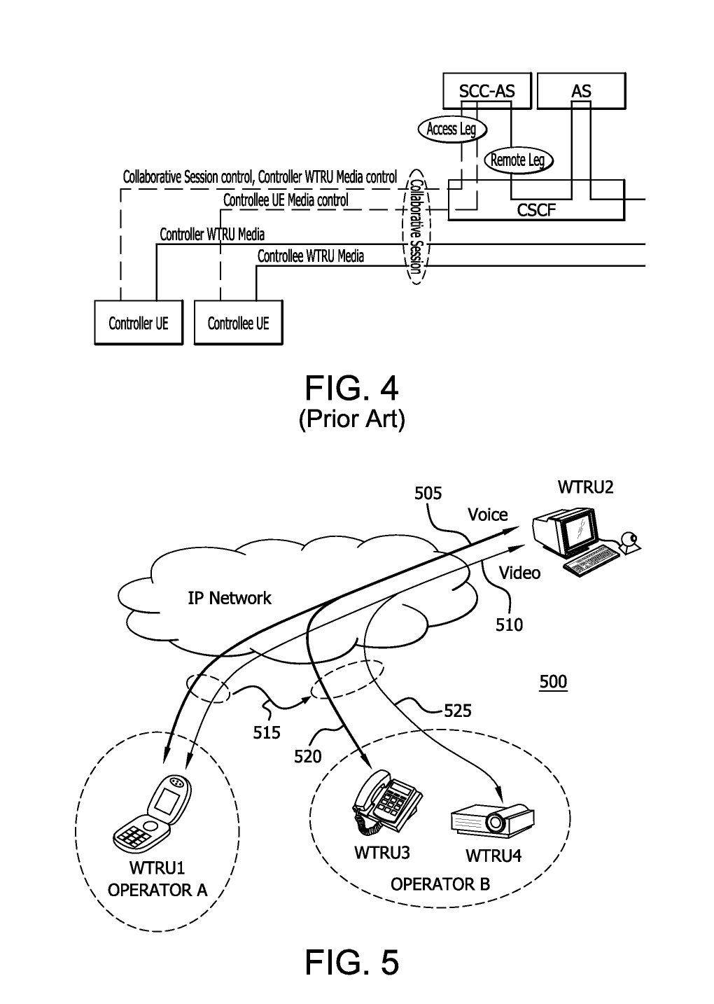

FIGS. 3 and 4 show example flowcharts of a single operator IDT. In general, the two figures show an information flow for a collaborative session establishment procedure when device WTRU-1 initiates media transfer from device WTRU-1 to WTRU-2. After the transfer, the device WTRU-1 becomes a controller device WTRU, and the device WTRU-2 becomes a controllee device WTRU.

In particular, there is an ongoing session between device WTRU-1 and a remote party. The session may be anchored at a Service Centralization and Continuity Application Server (SCC AS). The device WTRU-1 may transfer the media flow from device WTRU-1 to device WTRU-2 to establish a collaborative session. A collaborative session may be a session split across a plurality of device WTRUs and may be anchored in the SCC AS. It may be established in accordance with IDT procedures. The device WTRU that is initiating the IDT in order to establish the collaborative session, becomes the controller device WTRU. Other device WTRUs involved in the collaborative session become controlee device WTRUs. Subsequent IDTs, initiated by the controller device WTRU, may also be performed in the collaborative session. The SCC AS provides coordination of the collaborative session procedures, which may involve both the controller device WTRU and controlee device WTRU. A complete multi-media session may be transferred from one device WTRU to another device WTRU via IDT of the collaborative session.

As shown in FIGS. 3 and 4, there is a media flow-A between device WTRU-1 and a remote party. A device WTRU-1 may then send an IDT media transfer request to the SCC AS to transfer media flow-A from device WTRU-1 to device WTRU-2. The IDT media transfer request may include information to identify that the transferred media flow is media flow-A, identify that the target of the transferred media flow is device WTRU-2, and to keep the control of the collaborative session in device WTRU-1. The SCC AS may then send a request to establish an Access Leg at device WTRU-2 for media flow-A. The SCC AS may then remove media flow-A from device WTRU-1, and update a Remote Leg using a Remote Leg Update procedure. The SCC AS may then send an IDT media transfer response to device WTRU-1. A collaborative session is established, for which device WTRU-1 becomes the controller device WTRU and device WTRU-2 becomes a controllee device WTRU. When the above transfer is complete, the SCC AS retains the service state, (e.g. media flows status) of device WTRU-1 and device WTRU-2, WTRU-1 may transfer other media flows from device WTRU-1 using the procedure above.

The above describe single operator IDTs. These may not be applicable for inter-operator IDTs. For example, FIG. 5 shows an example diagram 500 overview of an inter-operator IDT. An IMS user may have a multimedia session over a device WTRU-1 subscribed with operator A, having a voice media component 505 and video media component 510. Subsequently, the IMS user may initiate an IDT 515 of the voice media component 505 from device WTRU-1 subscribed in operator A to device WTRU-3 subscribed with operator B (520) and the transfer of the video media component 510 from device WTRU-1 subscribed with operator A to device WTRU-4 subscribed with operator B (525). Methods are needed to perform IDT in multiple operator scenarios.

Described herein are methods for pull based inter-operator IDTs that may be anchored solely at a source operator, solely at a target operator or jointly at the source and target operators. In these methods, a target device may discover sessions or media flows on a source device and pulls the session or media flow components.

In general, a target device may initiate an IDT by requesting, for example, media to be transferred from a source device to a target device. The target device needs to be aware of the ongoing session in which a source device is involved in with the remote device. This may be achieved by the target device subscribing to a dialog-event package The dialog-event package, for example, may be an event package defined as a Session Initiation Protocol (SIP) extension, (e.g., using the SIP methods of SUBSCRIBE and NOTIFY), that may allow one user to subscribe to another user and receive notification of the changes in the state of dialogs that the subscribed to user is involved with. The device requesting session discovery information may then gain knowledge of the available sessions for IDT and also the nature of these sessions such as the media flows involved from the source device. However, other alternatives may be used to obtain this information. The request for IDT may occur from the target device currently not involved in the session that is ongoing between the source device and remote device. The request, (i.e. INVITE), may contain an offer indicating which media components the target device wants transferred to itself. The initiator of the IDT may generally be regarded as the controller of the collaborative session independent of whether the source, target or both operators act as the anchor for the IDT.

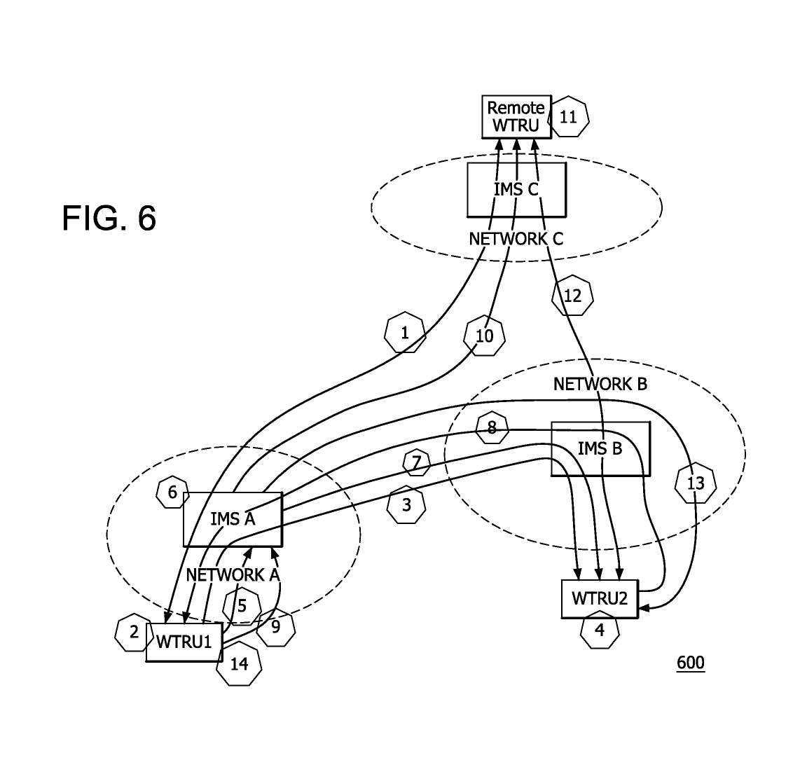

FIG. 6 shows an example diagram 600 of a pull based inter-operator IDT that is anchored at a source operator. Initially, a device WTRU1 is in a multimedia session with a remote device WTRU where the session may include more than one media component (1). The device WTRU1 may be subscribed with a network A and may interact with IMS A. The IMS A may include multiple entities including, for example, SCC AS A and call session control function (CSCF) A. The remote device WTRU may be subscribed with a network C and may interact with IMS C. The device WTRU1 may wish to transfer some media components from itself to the device WTRU2, which may be subscribed with a network B (2) and may interact with IMS B. IMS B and IMS C may be similar to IMS A. A check for the device WTRU2's availability and media capabilities may be made by the device WTRU1 (3). The device WTRU2 may be available for IDT and may respond to the device WTRU1 with an acknowledgment and media capability information (4). For the diagrams and flow diagrams discussed herein, the capabilities request and response, (i.e., steps (3) and (4) in FIG. 6), may be optional.

The device WTRU1 may initiate an IDT by sending an offerless session establishment request towards the device WTRU2 (5). The SCC AS A may anchor the signalling (6) and may send the IDT request towards the device WTRU2 (7). The device WTRU2 may accept and respond with an offer indicating the media capabilities of the device WTRU2, including codecs, ports and IP addresses (8). The device WTRU1 may respond with an answer including the media components to be transferred (9).

The SCC AS A may update the remote end with the modified session information, including the device WTRU2 IP address, ports and the like for media transfer to the device WTRU2 (10). The remote device WTRU may accept update and send back a response to acknowledge the session modification (11). A new media path between the device WTRU2 and the remote device WTRU may be established (12). An acknowledge (ACK) message may be sent containing an answer to the offer made by the device WTRU2 in response to the IDT request (13). The device WTRU1 may be instructed to remove the transferred media from itself since it has now been transferred to the device WTRU2 (14).

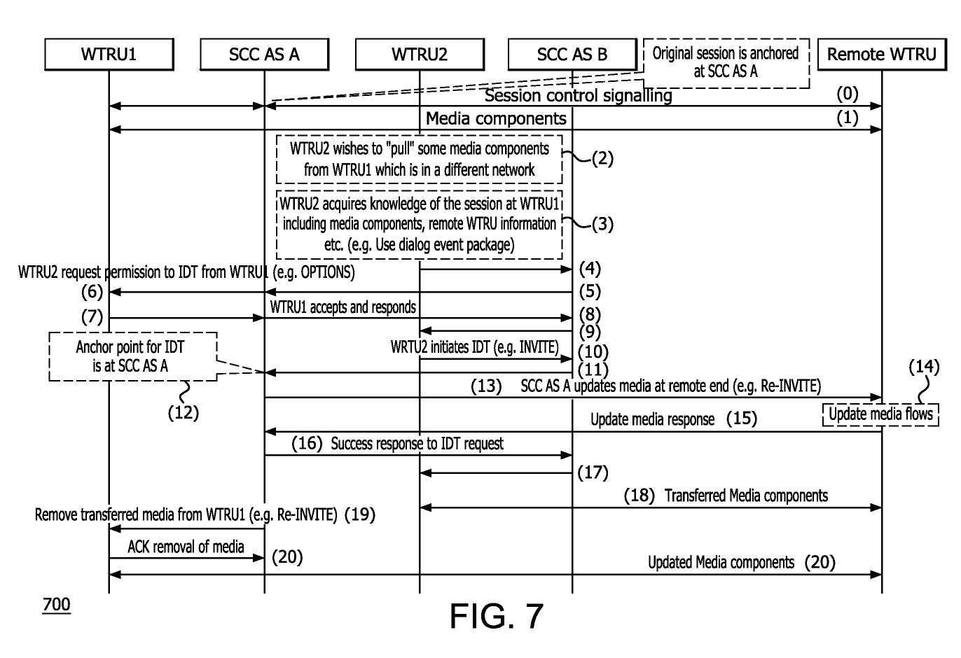

FIG. 7 shows an example flow diagram 700 of a pull based inter-operator IDT that is anchored at a source operator, i.e., at a SCC AS A. Initially, there is an ongoing session between a device WTRU1 and a remote device WTRU, where the device WTRU1 and the remote device WTRU may send media components information between themselves (1). That is, the media flow may be unidirectional or bidirectional. The device WTRU1 may be subscribed to a network A. The ongoing or original session may be anchored at the SCC AS A and session control signaling between the device WTRU1 and the remote device WTRU may be done by the SCC AS A (0).

A device WTRU2 may be subscribed with a network B and may wish to pull media components from the device WTRU1 (2). The device WTRU2 may acquire knowledge of the session at device WTRU1 including media components, remote device WTRU information, and the like (3). For example, a dialog event package may be used to obtain this information. The device WTRU2 may notify a SCC AS B that it wishes to perform an IDT with the device WTRU1 (4). The SCC AS B may send the device WTRU2 request to the device WTRU1 (6) via the SCC AS A (5). The request message may be a SIP OPTIONS message as defined in Request For Comments (RFC) 3261. In general, the SIP OPTIONS message may be a capabilities query which does not result in a dialog. The device WTRU1 may accept and respond by sending a message to the SCC AS B (8) via the SCC AS A (7). The SCC AS B then forwards the message to the device WTRU2 (9).

The device WTRU2 may send a message to the SCC AS B to initiate the IDT with the device WTRU1 (10). The message may by sent via, for example, an INVITE message. The SCC AS B then communicates or forwards the message to the SCC AS A (11). As noted earlier, the anchor point for the IDT may be at the SCC AS A and it may control the signaling for the IDT (12).

As the anchor point for the IDT, the SCC AS A may update the media at the remote end, by sending, for example, a Re-INVITE message to the remote device WTRU (13). The remote device WTRU may update the media flows (14) and may communicate the same to the SCC AS A (15). The SCC AS A may send a message to the SCC AS B indicating a successful response to the IDT request (16). The SCC AS B then communicates the same to the device WTRU2 (17). Media components are transferred between the device WTRU2 and the remote device WTRU (18).

The SCC AS A may remove the transferred media from the device WTRU1 by sending, for example, a Re-INVITE message (19). The device WTRU1 may then send an ACK message to the SCC AS A confirming the removal of the media (20). The device WTRU1 and the remote device WTRU may then update the media components information between themselves (21).

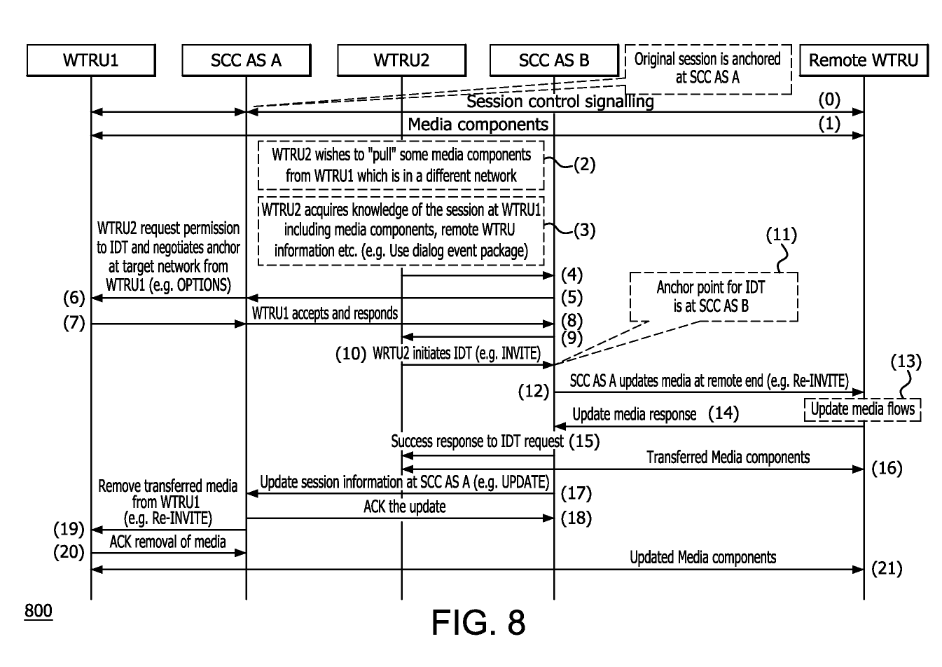

FIG. 8 shows an example flow diagram 800 of a pull based inter-operator IDT that is anchored at a target operator, i.e., at a SCC AS B. Initially, there is an ongoing session between a device WTRU1 and a remote device WTRU, where the device WTRU1 and the remote device WTRU may send media components information between themselves (1). The device WTRU1 may be subscribed to a network A. The ongoing or original session may be anchored at the SCC AS A and session control signaling between the device WTRU1 and the remote device WTRU may be done by the SCC AS A (0).

A device WTRU2 may be subscribed with a network B and may wish to pull media components from the device WTRU1 (2). The device WTRU2 may acquire knowledge of the session at the device WTRU1 including media components, remote device WTRU information, and the like (3). For example, a dialog event package may be used to obtain this information. The device WTRU2 may notify a SCC AS B that it wishes to perform an IDT with device WTRU1 and negotiate with the device WTRU1 that the IDT anchor point may be at the SCC AS B (4). The SCC AS B may then send the device WTRU2 request message to the device WTRU1 (6) via the SCC AS A (5). The message may, for example, an OPTIONS message. The device WTRU1 may accept and respond by sending a message to the SCC AS B (8) via SCC AS A (7). The SCC AS B then forwards the message to the device WTRU2 (9).

The device WTRU2 may then send a message to the SCC AS B to initiate the IDT with device WTRU1 (10). As noted earlier, the SCC AS B may be the anchor for the IDT and may control the IDT signaling (11). The SCC AS B may update the media at the remote end by sending, for example, an INVITE message to the remote device WTRU (12). The remote device WTRU may update the media flows (13) and may communicate the same to the SCC AS B (14). The SCC AS B may then inform the device WTRU2 with respect to a successful IDT request (15). Media components are transferred between the device WTRU2 and the remote device WTRU (16).

The SCC AS B may then update the session information at the SCC AS A by sending, for example, an UPDATE message (17). In response to the UPDATE message, the SCC AS A may send an ACK message to the SSC AS B (18). The SCC AS A may also remove the transferred media from the device WTRU1 by sending, for example, a Re-INVITE message (19). The device WTRU1 may then send an ACK message to the SCC AS A confirming the removal of the media (20). The device WTRU1 and the remote device WTRU may then update the media components information between themselves (21).

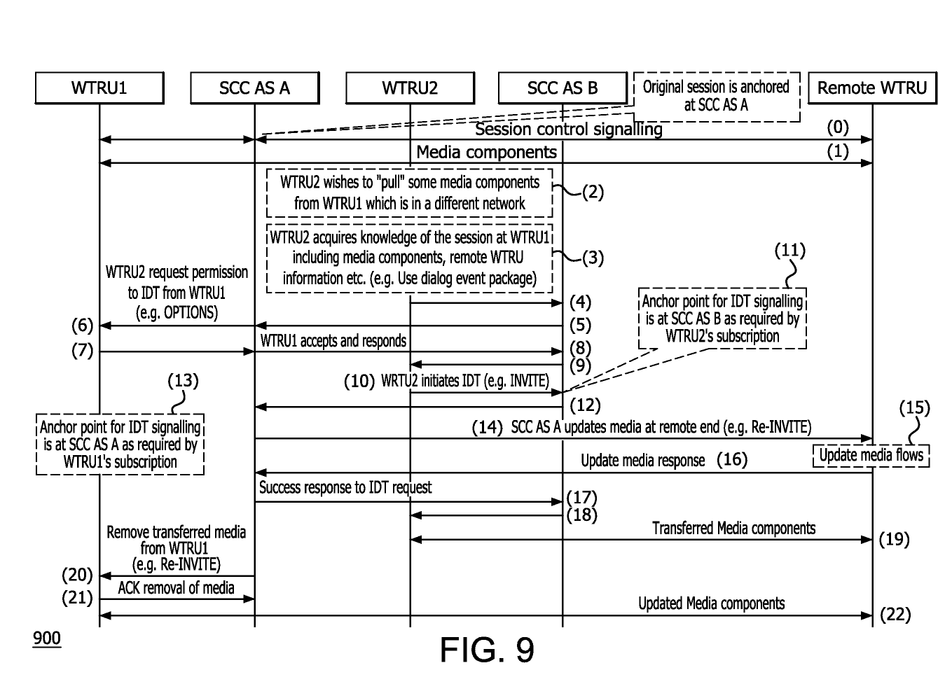

FIG. 9 shows an example flow diagram 900 of a pull based inter-operator IDT that is anchored at both source and target operators, i.e., at a SCC AS A and a SCC AS B. In general, both the SCC AS A and SCC AS B may perform or function as anchors for the IDT signaling. The SCC AS A may anchor the signaling for the original session and the SCC AS B may anchor signaling from the target device. In this scenario, the SCC AS A may continue to communicate session updates to the remote device WTRU and may be removed from the signaling path if the source device may eventually be removed from the collaborative session that included both the source and target devices.

Initially, there is an ongoing session between a device WTRU1 and a remote device WTRU, where the device WTRU1 and the remote device WTRU may send media components information between themselves (1). The device WTRU1 may be subscribed to a network A. The ongoing or original session may be anchored at the SCC AS A and session control signaling between the device WTRU1 and the remote device WTRU may be done by the SCC AS A (0).

A device WTRU2 may be subscribed with a network B and may wish to pull media components from the device WTRU1 (2). The device WTRU2 may acquire knowledge of the session at the device WTRU1 including media components, remote device WTRU information, and the like (3). For example, a dialog event package may be used to obtain this information. The device WTRU2 may notify the SCC AS B that it wishes to perform an IDT with the device WTRU1 (4). The SCC AS B may send the device WTRU2 request to the device WTRU1 (6) via the SCC AS A (5). The request message may be, for example, an OPTIONS message. The device WTRU1 may accept and respond by sending a message to the SCC AS B (8) via SCC AS A (7). The SCC AS B then forwards the message to the device WTRU2 (9). In an example method, steps (4)-(9) may be optional.

The device WTRU2 may send a message to the SCC AS B to initiate the IDT with the device WTRU1 (10). The message may by, for example, an INVITE message. As noted earlier, the anchor point for this example IDT may be distributed or shared between the SCC AS A and the SCC AS B. In this instance, the SCC AS B may control the signaling with respect to the device WTRU2 (11). The SCC AS B may communicate the device WTRU2 message to the SCC AS A (12). Again, the anchor point may be shared between the SCC AS A and the SCC AS B. The SCC AS A may control the signaling for the IDT with respect to the device WTRU1 (13). As the anchor point for the IDT with respect to the device WTRU1, the SCC AS A may update the media at the remote end, by sending, for example, a Re-INVITE message to the remote device WTRU (14). The remote device WTRU may update the media flows (15) and may communicate the same to the SCC AS A (16).

The SCC AS A may then send a message to the SCC AS B indicating the successful response to the IDT request (17). The SCC AS B then communicates the same to the device WTRU2 (18). Media components are then transferred between the device WTRU2 and the remote device WTRU (19).

The SCC AS A may remove the transferred media from the device WTRU1 by sending, for example, a Re-INVITE message (20). The device WTRU1 may then send an ACK message to the SCC AS A confirming the removal of the media (21). The device WTRU1 and remote device WTRU may then update the media components information between themselves (22).

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1. A method implemented at a target wireless transmit/receive unit (WTRU) for performing an inter-operator inter-device transfer (IDT), comprising:
transmitting an IDT request to transfer certain media to the target WTRU from an on-going session between a source WTRU and a remote WTRU, the target WTRU and the source WTRU being subscribed with different operators; and
establishing a collaborative session with at least the source WTRU for authorized transfer of the certain media.

2. The method of claim 1, further comprising:
acquiring information regarding the on-going session.

3. The method of claim 1, wherein the IDT request is transmitted to a service centralization and continuity application server (SCC AS) corresponding to the target WTRU.

4. The method of claim 3, wherein the IDT request is transmitted to a SSC AS corresponding to the source WTRU.

5. The method of claim 1, wherein the target WTRU is uninvolved in the on-going session.

6. A method implemented at a server for performing an inter-operator inter-device transfer (IDT), comprising:
receiving an IDT request from a target wireless transmit/receive unit (WTRU) to transfer certain media to the target WTRU from an on-going session between a source WTRU and a remote WTRU, the target WTRU and the source WTRU being subscribed with different operators;
authorizing the IDT request; and
establishing a collaborative session between at least the target WTRU and the source WTRU with respect to the certain media.

7. The method of claim 6, further comprising:
removing the certain media from the source WTRU.

8. The method of claim 6, further comprising:
updating the remote WTRU with respect to transfer of the certain media.

9. The method of claim 6, further comprising:
updating the source WTRU with respect to transfer of the certain media.

10. The method of claim 6, further comprising:
transferring the certain media from the source WTRU to the target WTRU.

11. The method of claim 6, wherein control of the collaborative session is with the server.

12. The method of claim 7, wherein the server is associated with the source WTRU and communicates with a second server associated with the target WTRU.

13. The method of claim 12, wherein the server and the second server are service centralization and continuity application servers (SCC AS).

14. A target wireless transmit/receive unit (WTRU) for performing an inter-operator inter-device transfer (IDT), comprising:
a transmitter configured to transmit an IDT request to transfer certain media to the target WTRU from an on-going session between a source WTRU and a remote WTRU, the target WTRU and the source WTRU being subscribed with different operators;
a processor in communication with the transmitter;
a receiver in communication with the processor; and
the processor, transmitter and receiver configured to establish a collaborative session with at least the source WTRU for authorized transfer of the certain media.

15. The WTRU of claim 14, further comprising:
the receiver and the processor being configured to acquire information regarding the on-going session.

16. The WTRU of claim 14, wherein the IDT request is transmitted to a service centralization and continuity application server (SCC AS) corresponding to the target WTRU.

17. The WTRU of claim 14, wherein the target WTRU is uninvolved in the on-going session.

18. A server for performing an inter-operator inter-device transfer (IDT), comprising:
a receiver configured to receive an IDT request from a target wireless transmit/receive unit (WTRU) to transfer certain media to the target WTRU from an on-going session between a source WTRU and a remote WTRU, the target WTRU and the source WTRU being subscribed with different operators;
a processor in communication with the receiver and a transmitter, the processor configured to authorize the IDT request; and
the processor, receiver and transmitter configured to establish a collaborative session between at least the target WTRU and the source WTRU with respect to the certain media.

19. The server of claim 18, further comprising:
the processor being configured to remove the certain media from the source WTRU.

20. The server of claim 18, further comprising:
the processor and transmitter being configured to update the remote WTRU with respect to transfer of the certain media and the source WTRU with respect to transfer of the certain media.

21. The server of claim 18, wherein control of the collaborative session is with the server.
